(19) United States
(12) Patent Application Publication
(10) Pub. No.: US 2004/0204135 A1
(43) Pub. Date: Oct. 14, 2004

(54) Multimedia editor for wireless communication devices and method therefor

(76) Inventors: Yilin Zhao, Northbrook, IL (US); Bo Tan, Vernon Hills, IL (US)

Correspondence Address: Randi L. Dulaney, Motorola, Inc., Law Department, 8000 West Sunrise Boulevard, Fort Lauderdale, FL, 33322, US

(21) Appl. No.: 10/313,794

(22) Filed: Dec. 6, 2002

(51) Int. Cl. H04Q 7/32

(52) U.S. Cl. 455/566; 455/575.1

(57) ABSTRACT

A multimedia editor (160) for use within a wireless communication device (10) includes a user interface (60), a content memory (90), a multimedia editor application (65), one or more decoders (125, 130, 135, 138), and a mixer/synchronizer (150). The multimedia editor (160) creates original multimedia content (140) using voice, singing, text, background sound, as well as music, graphics, image, audio, and video selected from one or more multimedia content (105) stored in the content memory (90).

### BACKGROUND OF THE INVENTION

1. Field of the Invention

This invention relates in general to wireless communication devices and more particularly to wireless communication devices with multimedia content.

2. Description of the Related Art

Historically, wireless communication devices, such as cellular telephones and two way messaging devices, have had the ability to receive and/or transmit data and/or voice messages sent from a wireless communication system, and perform standard functions in response to message receipt such as storing the message, displaying the message, or alerting the user of receipt of the message. Data messages are typically a numeric message such as a phone number, or an alphanumeric message containing one unique piece of information such as “meeting in my office at 6:00 pm.”

The user is alerted of receipt of a new message by an audible alert or a vibratory alert. The display of many wireless communication devices today includes a message indicator for each message it has received and stored in memory. This message indicator allows a quick view for the user of how many messages are in the wireless communication device and also allows the user to quickly pick a message to view. The display further can include a call receipt message indicating to the user a new call is being received and/or the source of the new call.

Today, methods and systems have been developed to transmit multimedia content to wireless communication devices. For instance, a video clip can be sent to the device, which includes music, images, human voice, etc. A ring tone can be downloaded from an Internet web site to the device for later use. One drawback of current approaches is that the multimedia content is created somewhere else. The device can only passively playback the content in traditional systems. Recently, technology has been developed to allow Musical Instrument Digital Interface (MIDI) files to be downloaded to and then edited on the receiving device.

One of the most popular techniques of obtaining multimedia content is via the Internet. The Internet is collection of over 25,000 computer networks connected through a communication backbone (NSFNET backbone) funded by the National Science Foundation (NSF) and is currently managed by Advanced Network System (ANS). A subscriber obtains an account with an organization's host computer (server) that is connected to the Internet through one or more networks. Traditionally, the subscriber is connected to the server through telephone lines using a personal computer (PC) and a modem. As use of the Internet becomes more popular, different methods of accessing the Internet have been developed. For example, users can access the Internet using a wireless communication device.

One drawback of receiving the multimedia content on a wireless communication device via various wireless communication systems today is the amount of channel space required to send the multimedia content.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is an electronic block diagram of a wireless communication device, in accordance with a preferred embodiment of the present invention.

FIG. 2 is an electronic block diagram of one embodiment of a multimedia editor as implemented within the wireless communication device of FIG. 1, in accordance with a preferred embodiment of the present invention.

FIG. 3 illustrates one embodiment of the output of the multimedia editor of FIG. 2 in accordance with the present invention.

FIG. 4 illustrates one embodiment of a control change message included within the output of FIG. 3 in accordance with the present invention.

FIGS. 5 through 7 are flowcharts illustrating various embodiments of the operation of the multimedia editor of FIG. 2, in accordance with the present invention.

FIGS. 8 and 9 illustrate two example applications of the present invention.

### DETAILED DESCRIPTION OF THE PREFERRED EMBODIMENT(S)

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention.

The terms a or an, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly, and not necessarily mechanically. The terms program, software application, and the like as used herein, are defined as a sequence of instructions designed for execution on a computer system. A program, computer program, or software application may include a subroutine, a function, a procedure, an object method, an object implementation, an executable application, an applet, a servlet, a source code, an object code, a shared library/dynamic load library and/or other sequence of instructions designed for execution on a computer system.

The present invention provides a method for a wireless communication device to manipulate various multimedia content to create original content. Using the present invention, the device can utilize existing multimedia engines, decoders, and vocoders (wireless communication device voice encode/decode engine) to process content in whatever formats are available. The received and available multimedia content can, for example, be utilized by the device user to set a short greeting with music and voice or singing, create and transmit a short message with picture and music, create and transmit a multimedia message, create a unique ring-tone (such as using the combination of the user's own voice and a personalized MIDI ring-tone), and/or create and enjoy true Karaoke contents.

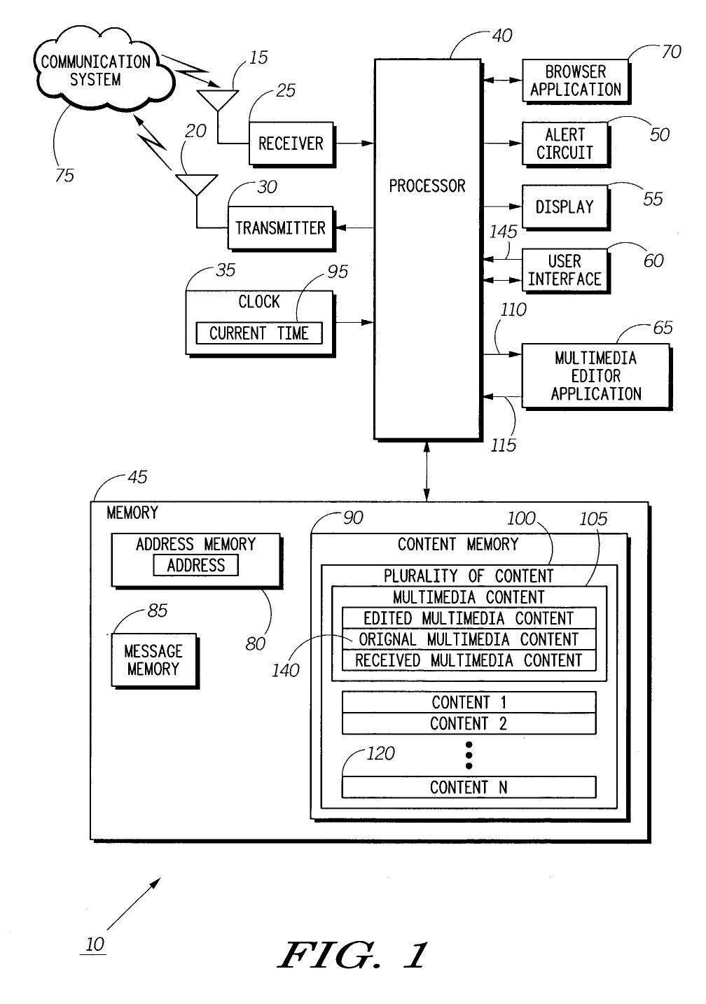

FIG. 1 is an electronic block diagram of a wireless communication device 10, in accordance with a preferred embodiment of the present invention. It will be appreciated by one of ordinary skill in the art that the wireless communication device in accordance with the present invention, can be a mobile cellular telephone, a mobile radio data terminal, a mobile cellular telephone having an attached or integrated data terminal, a personal digital assistance (PDA), or handheld computer, or a two way messaging device. In the following description, the term “wireless communication device” refers to any of the devices mentioned above or an equivalent.

The wireless communication device 10 includes a first antenna 15, a second antenna 20, a receiver 25, a transmitter 30, a clock 35, a processor 40, a memory 45, an alert circuit 50, a display 55, a user interface 60, and a multimedia editor application 65. In a preferred embodiment, the wireless communication device 10 further includes a browser application 70. It will be appreciated by one of ordinary skill in the art that the multimedia editor application 65 and the browser application 70 can be a software program or any other equivalent.

The first antenna 15 intercepts transmitted signals from a communication system 75. The transmitted signals, for example, can be a data message or a voice call. It will be appreciated by one of ordinary skill in the art that the communication system 75, in accordance with the present invention, can function utilizing any wireless RF channel, for example, a two-way messaging channel, a mobile cellular telephone channel, or a mobile radio channel. Similarly, it will be appreciated by one of ordinary skill in the art that the communication system 75 can function utilizing other types of wireless communication channels such as infrared, Bluetooth, IEEE 802.11, and/or HiperLan. It will be appreciated by one of ordinary skill in the art that the communication system 75 can alternatively function utilizing a wireline/wireless communication channel such as a local area network (LAN) or a wide area network (WAN) or a combination of both. The LAN, for example, can employ any one of a number of networking protocols, such as TCP/IP (Transmission Control Protocol/Internet Protocol), AppleTalk™, IPX/SPX (Inter-Packet Exchange/Sequential Packet Exchange), Net BIOS (Network Basic Input Output System) or any other packet structures to enable the communication among devices and/or between the devices and the shared resources. The WAN, for example, can use a physical network media such as X.25, Frame Relay, ISDN, Modem dial-up or other media to connect devices or other local area networks. In the following description, the term “communication system” refers to any one or combination of the wireless communication systems or wireline communication systems mentioned above or an equivalent.

The first antenna 15 is coupled to the receiver 25, which employs conventional demodulation techniques for receiving the communication signals transmitted by the communication system 75. Coupled to the receiver 25, is the processor 40 utilizing conventional signal-processing techniques for processing received messages. Preferably, the processor 40 is similar to the MC68328 micro-controller manufactured by Motorola, Inc. of Schaumburg, Ill. It will be appreciated by one of ordinary skill in the art that other similar processors can be utilized for the processor 40, and that additional processors of the same or alternative type can be utilized as required to handle the processing requirements of the processor 40.

In accordance with the present invention, each communication device has an address or identity assigned thereto which is a unique address in the communication system 75 for receiving and transmitting messages. Each address enables the transmission of a message, only to the communication device having the address, and identifies the messages and responses received from the communication device with the address. Upon the wireless communication device 10 receiving a message, the processor 40 decodes an address in the demodulated data of the received message, compares the decoded address with one or more addresses stored in an address memory 80 of the memory 45; and when a match is detected, proceeds to process the remaining portion of the received message.

To perform the necessary functions of the wireless communication device 10, the processor 40 is coupled to the memory 45, which preferably includes a random access memory (RAM), a read-only memory (ROM), a FLASH memory (not shown), and an electrically erasable programmable read-only memory (EEPROM)(not shown). The memory 45 is comprised of the address memory 80, a message memory 85, and a content memory 90.

A plurality of content 100 is stored in the content memory 90. The stored plurality of content 100, for example, can include singly or in combination Musical Instrument Digital Interface (MIDI) files, edited MIDI, MP3 files, other audio files, video files, graphics files, image files, voice or singing, background sound, text, Karaoke, still or video images, and the like. The plurality of content 100 stored in the content memory 90 can be received via the communication system 75, created on the device itself, or directly programmed via a wired communication system. The content sources, for example, can include singly or in combination MIDI, edited MIDI, MP3 (the file extension for MPEG (Moving Picture Experts Group) audio layer 3), JPEG (Joint Photographic Experts Group), GIF (graphics interchange format), WAV (the format for storing sound in files developed jointly by Microsoft and International Business Machines (IBM)), MPEG2, MPEG4, H.263, WMA (Windows Media Audio), WMV (Windows Media Video), voice, sound, singing, text, video, audio, Karaoke, or an equivalent.

Once the processor 40 has processed a received message, it stores the decoded message in the message memory 85. It will be appreciated by one of ordinary skill in the art that the message memory 85, in accordance with the present invention, can be a group of memory locations in a data storage device or an equivalent.

Upon receipt and processing of a message, the processor 40 preferably generates a command signal to the alert circuit 50 as a notification that the message has been received and stored. The alert circuit 50 can include a speaker (not shown) with associated speaker drive circuitry capable of playing voice, melodies, and other audible alerts, a vibrator (not shown) with associated vibrator drive circuitry capable of producing a physical vibration, one or more light emitting diodes (LEDs) (not shown) with associated LED drive circuitry capable of producing a visual alert, or a video imaging display capable of producing a visual video alert. It will be appreciated by one of ordinary skill in the art that other similar alerting means as well as any combination of the audible, vibratory, and visual alert outputs described can be used for the alert circuit 50.

Upon receipt of a message, the processor 40 preferably also generates a command signal to the display 55 to generate a visual notification of the receipt and storage of the message. When the display 55 receives the command signal from the processor 40 that the message has been received and stored in the message memory 85, a message indication is displayed. The message indication, for example can be the activation of one of a plurality of message icons on the display 55. The display 55 can be, for example, a liquid crystal display, a dot matrix display, or an equivalent.

The wireless communication device 10 preferably further includes the clock 35. The clock 35 provides timing for the processor 40. The clock 35 preferably includes a current time 95 for use in the operation of the wireless communication device 10. The clock 35 also provides a source for timing of feature enhancements such as active and inactive periods of operation or periods of alerting.

In a preferred embodiment, the wireless communication device 10 includes the multimedia editor application 65. The multimedia editor application 65 is programmed to edit and create one or more multimedia content 105 by using the plurality of content 100 stored in the content memory 90. The one or more multimedia content 105 thereafter can be stored in a memory location of the content memory 90 for further utilization. The one or more multimedia content 105, for example, can be used to create an alert using the alert circuit 50. The one or more multimedia content 105 further can be transmitted to one or more other devices using the transmitter 30.

The wireless communication device 10 performs multimedia editing functions within the multimedia editor application 65 using a processor command 110 sent from the processor 40. The multimedia editor application 65 sends an application response 115 in reply to the processor command 110. It will be appreciated by those of ordinary skill in the art that the multimedia editor application 65 can be hard coded or programmed into the wireless communication device 10 during manufacturing, can be programmed over-the-air upon customer subscription, or can be a downloadable application. It will be appreciated by one of ordinary skill in the art that other programming methods can be utilized for programming the multimedia editor application 65 into the wireless communication device 10.

The multimedia editor application 65, in response to the processor command 110, preferably accesses the content memory 90 of the memory 45. The multimedia editor application 65 is programmed with a set of rules identifying the management of one or more content 120 of the plurality of content 100 stored in the content memory 90. Alternatively, the multimedia editor application 65 can create original multimedia content 140.

The multimedia editor application 65 provides a means for a user community to share their creative multimedia content, to gain the attention of the people in the same user community, to attract others to join the community, and to create multimedia messages to serve their personal needs. For instance, using the MIDI and vocoder as the instruments and song encode/decode engines, the multimedia editor application 65 can create and initiate the playing of sound with a file size that can be 1/10 to 1/20 of the original MP3 file. Also, in accordance with the present invention, the multimedia editor application 65 can provide Karaoke functions such as muting, mixing, and playing original sound as well as recording a new sound. Another example of how a user community can utilize the multimedia editor application 65 is for a family's emergency assistance needs. For instance, the family can create one common multimedia message for 911 calls, one common message for medical attention, one common message for roadside assistance, and the like. Each original multimedia content 140 can trigger a unique call process for their respective assistance requests while sending one or more multimedia messages to other family members. For instance, once 911 is called, a picture of the current site along with a pre-selected emergency sound and the device user's location can be sent automatically to selected individuals.

Preferably, the user interface 60 is coupled to the processor 40. The user interface 60 can be one or more buttons or selections used to generate a button press, a series of button presses, a voice response from the device user, or some other similar method of manual response initiated by the device user of the wireless communication device 10. The processor 40, in response to a multimedia content creation and/or editing signal 145 from the user interface 60, initiates the processor command 110 to the multimedia editor application 65. The multimedia editor application 65, in response to the processor command 110 can alter the multimedia content portions and/or perform other actions on the one or more content 120 or on the one or more multimedia content 105. For example, pressing a button of the user interface 60 can cause an original multimedia content 140 to be implemented as the alert notification of a newly received data message or voice call.

The transmitter 30 is coupled to the processor 40 and is responsive to commands from the processor 40. When the transmitter 30 receives a command from the processor 40, the transmitter 30 sends a signal via the second antenna 20 to the communication system 75. The transmitted signal, for example, can include one or more multimedia content 105 created by the multimedia editor application 65.

In an alternative embodiment (not shown), the wireless communication device 10 includes one antenna performing the functionality of the first antenna 15 and the second antenna 20. Further, the wireless communication device 10 alternatively includes a transceiver circuit performing the functionality of the receiver 25 and the transmitter 30. It will be appreciated by one of ordinary skill in the art that other similar electronic block diagrams of the same or alternate type can be utilized for the wireless communication device 10 to handle the requirements of the wireless communication device 10.

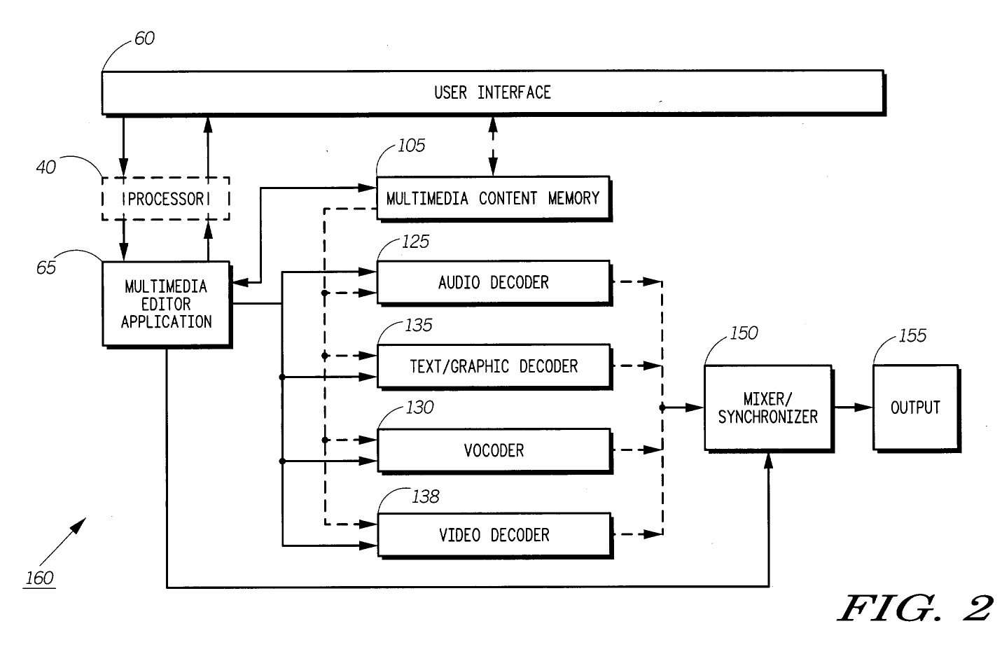

FIG. 2 is an electronic block diagram of one embodiment of a multimedia editor 160 as implemented within the wireless communication device of FIG. 1, in accordance with a preferred embodiment of the present invention. As illustrated, the multimedia editor 160 utilizes the multimedia editor application 65 along with other existing electronics within the wireless communication device 10 of FIG. 1. The multimedia editor 160, according to the present invention uses existing hardware components, uses existing engines, such as a MIDI engine, a MP3 engine, a audio decoder, a video decoder, a graphics decoder, a text decoder, and/or various vocoders, and requires no new formats from the content providers. The multimedia editor 160 provides a means for editing and creating multimedia content which gives the device user the freedom to create and or play one or more original multimedia content 140 using their wireless communication device 10.

As illustrated, the multimedia editor application 65 preferably is coupled either directly to the user interface 60 or indirectly through the processor 40 for receiving inputs from the device user as described previously herein. The user interface 60 preferably utilizes the one or more multimedia content 105 stored in the content memory 90 to provide various alerts, notifications, and other outputs to the device user himself/herself and/or to other users. The user interface 60 can access the one or more multimedia content 105 either directly or indirectly through the multimedia editor application 65. For example, the multimedia editor application 65 can be programmed to access the one or more multimedia content 105 stored in the content memory 90 in response to an input from the user interface 6Q. The multimedia editor application 65 is further coupled to one or more decoders such as an audio decoder 125 (such as one or more MIDI/MP3 engines), a vocoder 130, a text/graphics decoder 135, a video decoder 138, and the like for use by the multimedia editor application 65 in creating the original multimedia content 140. For example, the multimedia editor application 65 sends an instruction input to each of the one or more decoders associated with the desired one or more multimedia content after accessing the one or more multimedia content. A mixer/synchronizer 150 is electrically coupled to the multimedia editor application 65, and the outputs of the one or more decoders including the outputs of the audio decoder 125, the vocoder 130, the text/graphics decoder 135, and the video decoder 138. The output 155 from the mixer/synchronizer 150 includes the one or more multimedia content 105 including the original multimedia content 140.

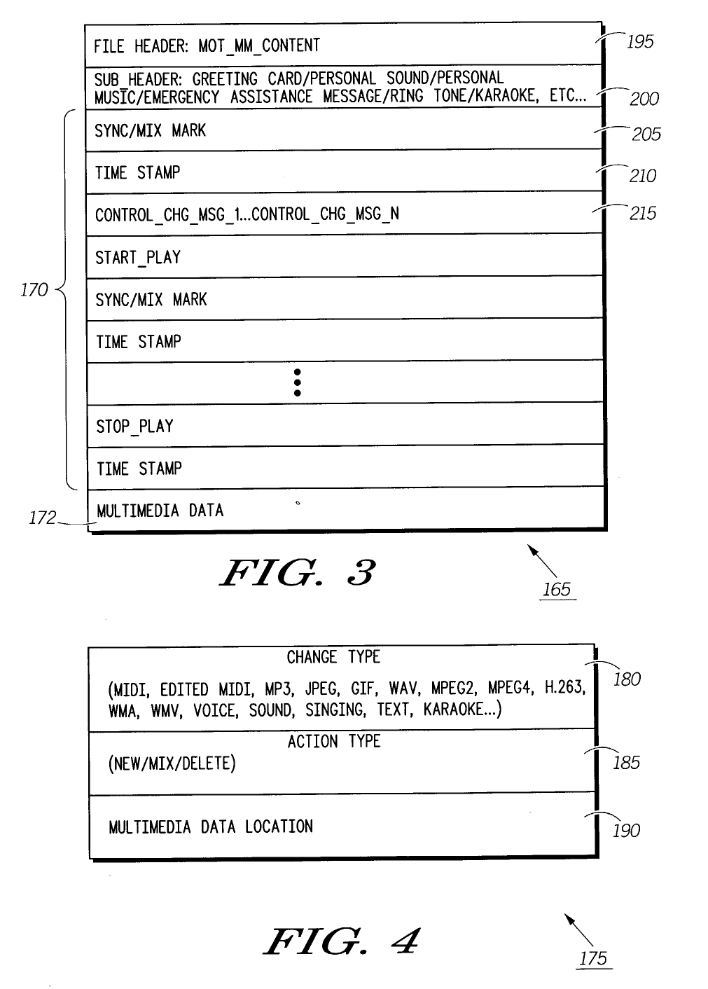

FIG. 3 illustrates a header file 165 contained within the output 155 of the multimedia editor 160 in accordance with a preferred embodiment of the present invention. The header file 165 as illustrated preferably contains one or more control information 170, and a file body 172 that contains original multimedia content 140 and/or one or more multimedia content 105 stored in the content memory 90. The header file 165, for example, includes a file header 195, a sub file header 200, a Synchronization/Mix Mark 205, a time stamp 210, and one or more control change messages 215.

FIG. 4 illustrates a control change message 175 of the one or more control change messages 215 in accordance with the present invention. The control change message 175 preferably includes a change type 180. The change type 180 can be, for example, a change to any combination of MIDI, edited MIDI, MP3, JPEG, GIF, WAV, MPEG2, MPEG4, H.263, WMA, WMV, voice, sound, singing, text, audio, video, Karaoke, or the like. The control change message 175 preferably further includes an action type 185. The action type 185 can, for example, can be new, mix, and/or delete existing content. The control change message 175 preferably further includes a multimedia data location 190. The multimedia data location 190 identifies a memory location within the content memory 90 in which the desired multimedia content is located.

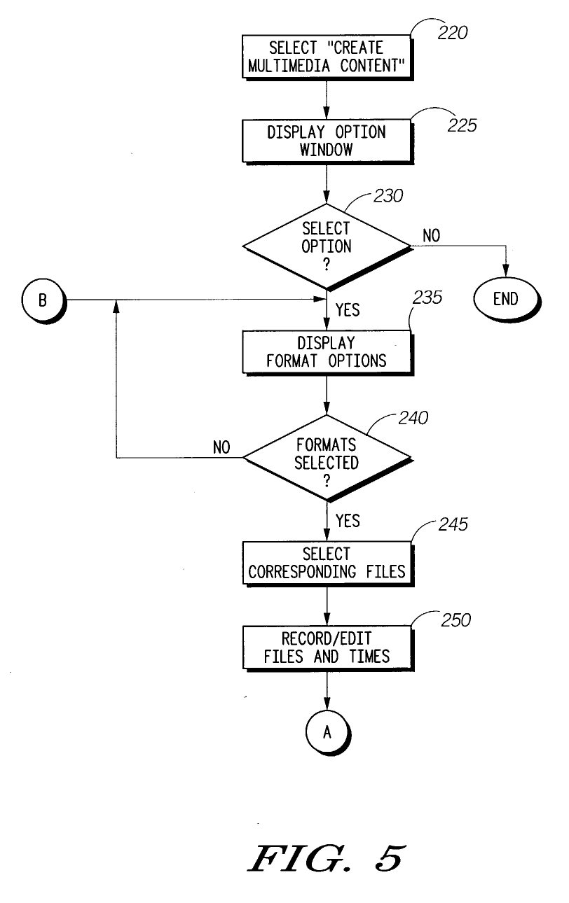

FIG. 5 is a flowchart illustrating one example of the operation of the multimedia editor 160 of FIG. 2, in accordance with the present invention. The multimedia editor 160 of FIG. 2 preferably creates an original multimedia content 140 within the wireless communication device 10 by selecting one or more content formats; selecting one or more content 120 stored within the content memory 90 using the selected one or more content formats; and recording a playback file including the selected one or more content 120 or receiving a playback file from another wireless communication device for playing.

In the illustrated example, a device user wants to send a multimedia greeting card to his mother during his vacation in a remote resort. For example, the device user has taken two scenery pictures with his wireless communication device 10. He has also downloaded a local song played by a local band from the Internet. The device user can send his mother a multimedia message that provides her the ability to listen to the local music while enjoying the scenery surrounding of the remote resort. FIG. 5 specifically illustrates the operation of the multimedia editor 160 to create original multimedia content. As illustrated in FIG. 5, in Step 220, using the user interface 60, the device user selects “Create Multimedia Content.” Next, in Step 225, in response to the selection, the user interface 60 pops up a window presenting a series of options such as greeting card, personal sound, personal music, personal ring tone, emergency assistance message, Karaoke, and the like. In Step 230, the process queries whether or not the device user has selected the “greeting card” option. In Step 235, when the device user has selected “Greeting Card”, the user interface 60 will present the device user with a series of selections for the background music format and the foreground graphics format. In Step 240, the process determines whether or not the device user has selected the background music format and/or the foreground graphic format. When the device user has not selected a format in Step 240, the process cycles back to Step 235. In Step 245, when the device user has selected the formats for the background music and/or the foreground graphics, the user interface 60 will prompt the device user to select corresponding files listed in a pop-up window. The corresponding files include all stored background music files stored in the content memory 90 using the selected background music format and/or all stored foreground graphics files stored in the content memory 90 using the selected foreground graphics format. For example, if the device user selects MIDI and JPEG as the formats for the background music and the foreground graphics respectively, the user interface 60 will prompt the device user to select corresponding files listed in a pop-up window, such as music1.mid and graph1.jpg. Next, in Step 250, Multimedia Editor 160 records the initial playback information that includes the playback files and the system timer. The playback files, for example, include the selected background music and the selected foreground graphics. It also initializes the timers of the playback files that will be used for the playback, mixer and synchronization. The process of FIG. 5 ends at node A.

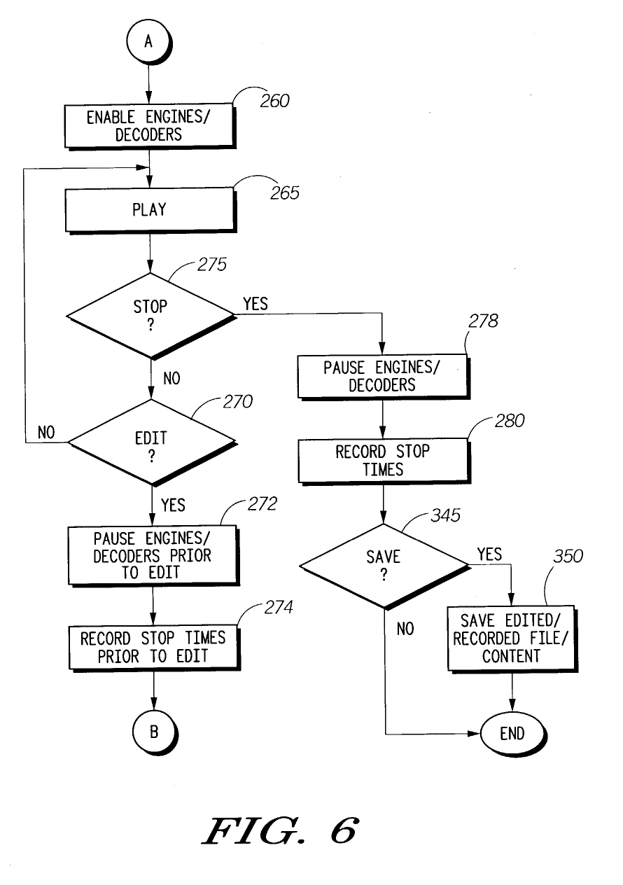

FIG. 6 is a flowchart illustrating further operation of the multimedia editor 160 of FIG. 2, in accordance with the present invention following from the example operation of FIG. 5. The process of FIG. 6 begins at node A. Next, in Step 260, the multimedia editor 160 enables at least one decoder associated with the selected one or more content formats chosen in Step 240 of FIG. 5 for use in playback of an original multimedia content. For example, when the selected one or more content formats includes a selected background music format and a selected foreground graphics format, the multimedia editor 160 enables at least one music decoder associated with the selected background music format and/or enables at least one graphics decoder associated with the selected foreground graphics format. One example is that, when appropriate, the multimedia editor 160 enables the MIDI engine and the JPEG decoder to playback the edited/recorded files of FIG. 5. Next, in Step 265, the edited/recorded files are played. For example, the graph1.jpg will be displayed on the display 55 and music1.mid will be played via the device speaker simultaneously. Next, in Step 275, the process determines whether or not “Stop” has been selected. For example, “Stop” can be selected by a device user input to the user interface 60. When “Stop” has not been selected in Step 275, in Step 270, the process determines whether or not the device user has selected to “Edit” the recorded multimedia content. When the device user has not selected to “Edit” the recorded multimedia content, the recorded files continue to be played. In Step 272, when the device user has selected to “Edit” the recorded multimedia content in Step 270, the multimedia editor 160 pauses the enabled one or more decoders. Next, in Step 274, the multimedia editor 160 records the stop times for each of the paused one or more decoders prior to editing the recorded multimedia content. The process of FIG. 6 then continues at node B which routes back to FIG. 5 Step 235. For example, the device user of this greeting card creation example can replace graphic1.jpg with graphic2.jpg while continuing to play music1.jpg.

In Step 278, when “Stop” has been selected in Step 275, the multimedia editor 160 pauses the enabled one or more decoders. Next, in Step 280, the multimedia editor 160 further records the stop times for each of the paused one or more decoders. The multimedia editor 160 records the stop time for each individual multimedia files. For instance, if the stop time is T1, the playback time for the music1.mid and graphic1.jpg is from 0 to T1. Next, at Step 345, the process determines whether or not the device user desires to save the edited/recorded file. When the device user does not desire to save the edited/recorded file, the process ends. At Step 350, when the device user selects “Save”, the edited/recorded playback file and its contents is saved. For example, the new file can consists of a header, music1.mid, graph1.jpg, and graph2.jpg. Some of these content files can be reduced in size based on their timers. The process of creating the original multimedia content then ends.

After editing is completed, the device user can play it back to see whether this greeting card is okay (not shown). If everything is acceptable to the device user, he can then send this new greeting card to his mother. The device user, for example, can transmit a message including the edited/recorded file via the communication system (75) to another communication device utilized by his mother. The edited/recorded file can then be stored within another communication device and played/viewed by the recipient device user. For example, the device user's mother can play the new multimedia content created by her son on her own cellular telephone in response to receipt of the message including the edited/recorded file.

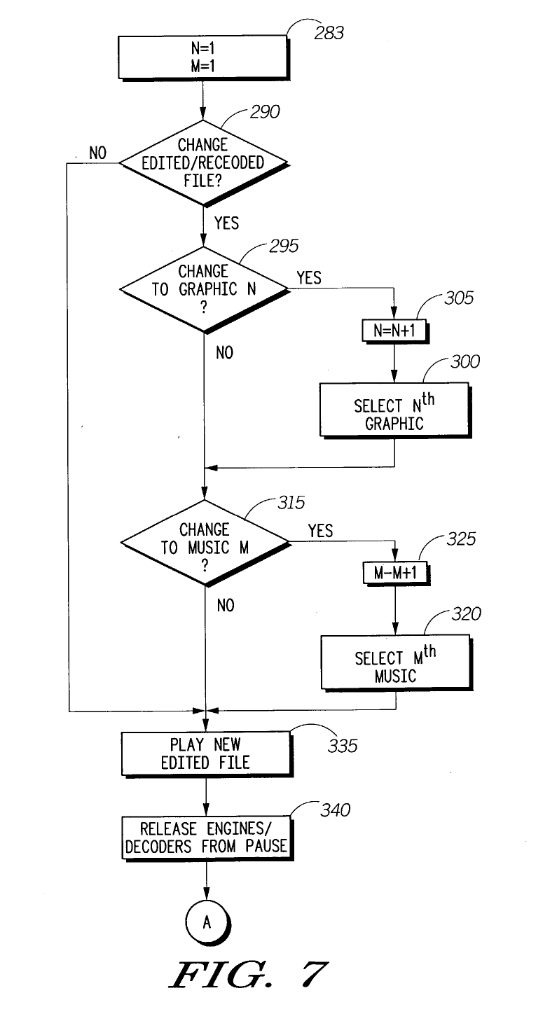

FIG. 7 is a flowchart illustrating further detail of the operation illustrated in FIGS. 5 and 6 of the multimedia editor 160 of FIG. 2, in accordance with the present invention. Specifically, the flowchart of FIG. 7 illustrates an example wherein the original multimedia content 140 included within the playback file includes graphic and music content. It will be appreciated by those of ordinary skill in the art that the process of FIG. 7 can alternatively be utilized for any of the plurality of content 100 utilized for creating the original multimedia content 140 in accordance with the present invention. The process of FIG. 7 begins at Step 283, in which a graphics counter is set to N=1; and a music counter is set to M=1. Next, in Step 290, the process determines whether or not the device user has selected to change the edited/recorded file. For example, the device user can select the “concatenate” option using the user interface 60. When the device user has not selected to change the recorded file in Step 290, the process continues at Step 335. In Step 295, when the device user has selected to change the file containing the original multimedia content 140 in Step 290, the process determines whether or not the user wants to change to the Nth graphic as the new foreground graphics. In Step 305, when the device user selects to change the graphic to the Nth graphic in Step 295, (wherein the Nth graphic is a replacement foreground graphics file), the graphics counter is incremented to N=N+1. Next, in Step 300, the device user selects the Nth foreground graphic, such as graph2.jpg. For example, the device user presses the “Concatenate” option to select the Nth image file. Next and when the device user does not select to change the graphic in Step 295, at Step 315 the process determines whether or not the device user has selected to change the music. In Step 325, when the device user selects to change the music to the Mth music in Step 315, the music counter is incremented to M=M+1 in Step 325. Next, in Step 320, the device user selects the Mth music, (wherein the Mth music is a replacement background music file). Next and when the device user does not select to change the music in Step 315, the process continues to Step 335 in which the device user reviews the new edited file. It will be appreciated by those of ordinary skill in the art that the new edited file includes the replacement foreground graphic and/or the replacement background music. For example, to review the new edited file, the device user can then presses “Play”. In this way, a device user can select different music, different images, audio, video, text or voice in any combination whenever it is desired. Next, in Step 340, the multimedia editor 160 releases the engines and decoders (such as the MIDI engine and JPEG decoder) from the pause state. The operation of FIG. 7 ends at node A in which the process cycles back to Step 260 of FIG. 6.

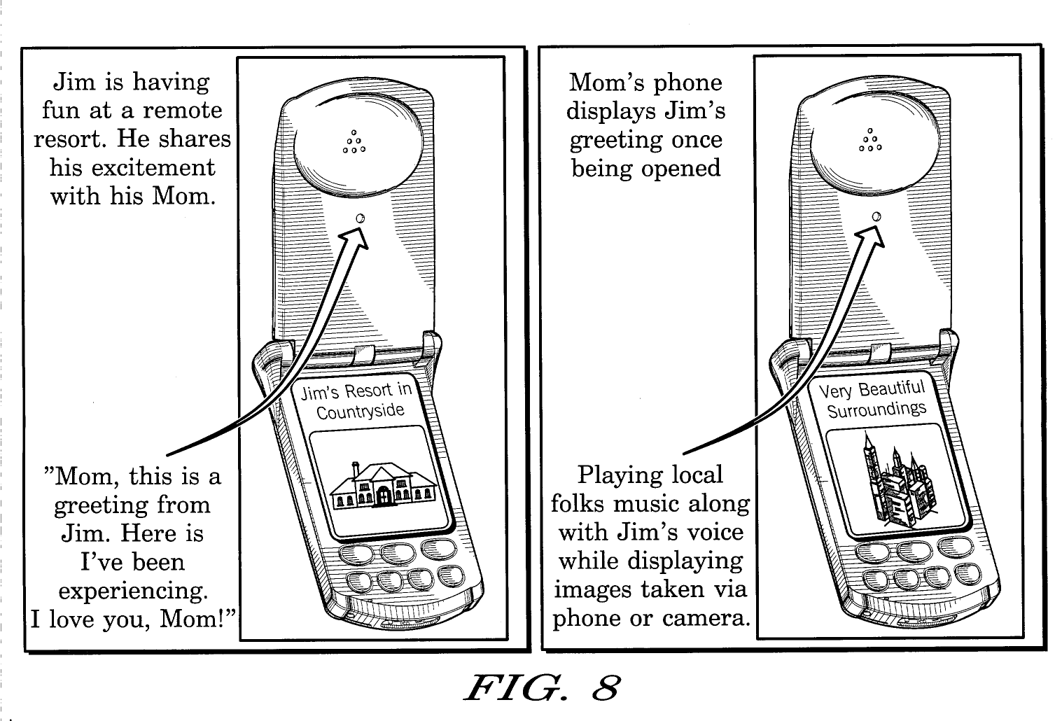

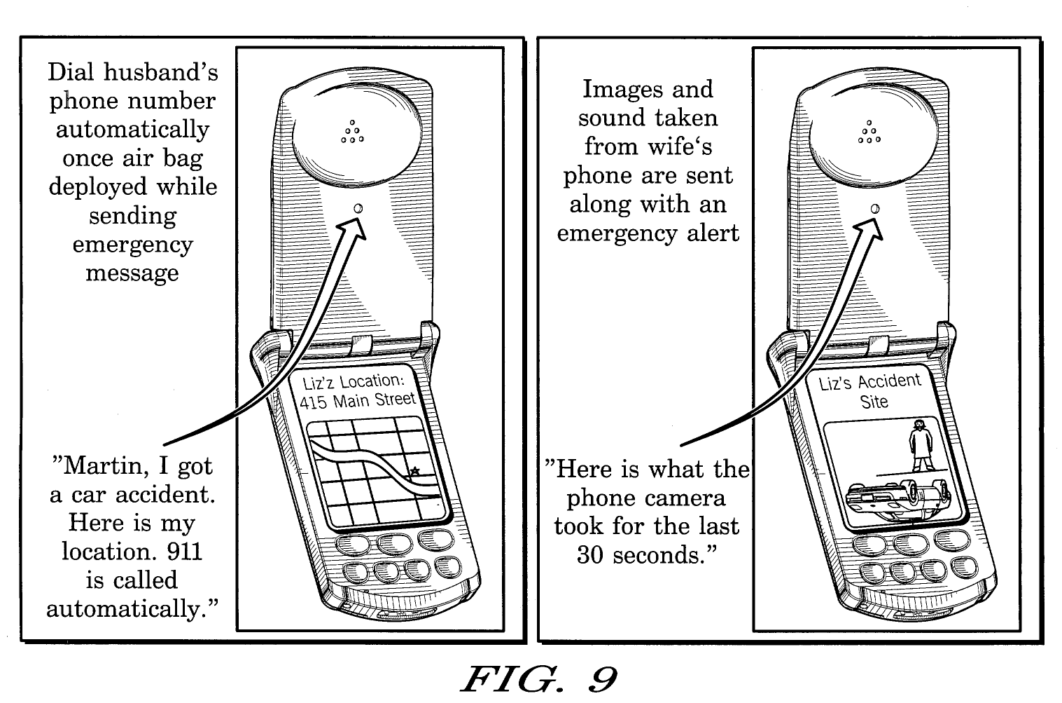

It will be appreciated by those of ordinary skill in the art that the multimedia editor 160 in accordance with the present invention can be used to implement various applications such as sending greetings including favorable music, image, plus own voice. FIG. 8 illustrates an example application of the present invention for sending a greeting. For example, Mom's phone beeps once her son's newly created multimedia content arrives.

As illustrated in FIG. 9, the present invention provides a beneficial means of communication in an emergency situation. For example, in accordance with the present invention, a device user can select one or more emergency content of the plurality of content 100 stored within the content memory 90. The original multimedia content 140 can then be created using the methods described previously herein using the selected one or more emergency content. When a device user provides an emergency user input to the user interface 60, the wireless communication device 10 can then transmit a message including the original multimedia content via the communication system 75. Preferably, the one or more emergency content includes a picture of the current site location of a device user, the location of the site if available, and an emergency sound. In one embodiment, the one or more emergency content can be classified and each classified content has a recipient list identified. One example of such a classification can be as follows: One content for 911, one for medical attention, and one for roadside assistance. Then, the message including the original multimedia content is transmitted to the recipient list of the classified content once triggered either by user's action or automatically by an associated event, such as the airbag deployment in a car collision accident.

For example, once an emergency user input to the user interface such as the buttons for 911 are pressed, a message including the original multimedia content 140 comprising a picture of the current site location of the device user along with a pre-selected emergency sound and the device user's location can be sent automatically to selected individuals. For example, husband's phone displays the two images shown in the figure alternatively until the husband takes actions. It will be appreciated by those of ordinary skill in the art that, in accordance with the present invention, a plurality of multimedia emergency messages can be created. Further, it will be appreciated that each of the plurality of multimedia emergency messages created can be classified into categories which define the message to transmit and the recipient lists to which the message is to be transmitted. The present invention further can be used to implement personalized ring tones including creating different ring tones for different sets of messages as well as to create and play Karaoke contents.

Although the invention has been described in terms of preferred embodiments, it will be obvious to those skilled in the art that various alterations and modifications can be made without departing from the invention. Accordingly, it is intended that all such alterations and modifications be considered as within the spirit and scope of the invention as defined by the appended claims.

What is claimed is:

1. A multimedia editor for use within a wireless communication device comprising:
a user interface for receiving a user input and for sending a content creation input to a multimedia editor application in response to receiving the user input;
a content memory for storing one or more multimedia content;
a multimedia editor application coupled to the user interface and further coupled to the content memory wherein the multimedia editor application is programmed to:
access the one or more multimedia content in response to the content creation input from the user interface,
send an instruction input to one or more decoders associated with each of the one or more multimedia content,
the one or more decoders coupled to the multimedia editor application enables at least one decoder in response to the instruction input from the multimedia editor application; and
a mixer/synchronizer coupled to the one or more decoders for generating an output comprising the one or more original multimedia content.

2. A multimedia editor as recited in claim 1, wherein the one or more decoders comprise one or more decoders selected from a group consisting of one or more audio decoders, one or more video decoders, one or more vocoders, one or more text decoders, and one or more graphics decoders.

3. A multimedia editor as recited in claim 1 wherein each of the one or more decoders is associated with a selected format for generating the output.

4. A multimedia editor as recited in claim 1 wherein the output further comprises an output selected from the group consisting of a file header, a sub file header, a synchronization/mix mark, a time stamp, and one or more control change messages.

5. A multimedia editor as recited in claim 4 wherein a control change message of the one or more control change messages comprises a message selected from a group consisting of a change type, an action type, and a multimedia data location.

6. A method for creating original multimedia content within a wireless communication device having a content memory, the method comprising:
selecting one or more content formats;
selecting one or more content files stored within the content memory using the selected one or more content formats; and
recording a playback file including the selected one or more content files.

7. A method for creating original multimedia content within a wireless communication device as recited in claim 6, wherein each of the one or more content formats is selected from a group consisting of one or more music formats, one or more graphic formats, one or more image formats, one or more audio formats, one or more video formats, one or more voice formats, one or more sound formats, and one or more text formats.

8. A method for creating original multimedia content within a wireless communication device as recited in claim 6, wherein the one or more content formats includes a background music format and a foreground graphics format.

9. A method for creating original multimedia content within a wireless communication device as recited in claim 6, wherein the wireless communication device further comprises one or more decoders, the method further comprising:
enabling the at least one decoder associated with the selected one or more content formats; and
playing the edited playback file using the at least one decoder.

10. A method for creating original multimedia content within a wireless communication device as recited in claim 6, the method further comprising:
changing the selected one or more content by selecting a replacement content from the one or more content files stored within the content memory; and
playing a new edited playback file including the replacement content.

11. A method for creating original multimedia content within a wireless communication device as recited in claim 10 wherein the selected one or more content comprises a foreground graphics and further wherein the replacement content comprises a replacement foreground graphics.

12. A method for creating original multimedia content within a wireless communication device as recited in claim 10 wherein the selected one or more content comprises a background music and further wherein the replacement content comprises a replacement background music.

13. A method for creating original multimedia content within a wireless communication device as recited in claim 10, wherein the wireless communication device further comprises a transmitter for transmitting messages via a wireless communication system, the method further comprising:
transmitting a message including the new edited playback file via the wireless communication system.

14. A method for creating original multimedia content within a wireless communication device as recited in claim 13 further comprising:
receiving the message by another communication device; and
playing the edited playback file using the another communication device.

15. A method for creating and communicating original multimedia content within a wireless communication device having a transmitter for transmitting one or more messages, a content memory for storing a plurality of content, and a user interface, the method comprising:
selecting one or more emergency content of the plurality of content stored within the content memory;
creating an original multimedia content including the selected one or more emergency content;
transmitting a message including the original multimedia content via the wireless communication system in response to an emergency user input to the user interface.

16. A method for creating and communicating original multimedia content within a wireless communication device as recited in claim 15 wherein the one or more emergency content comprises:
a picture of the current site location of a device user; and
an emergency sound.

17. A method for creating and communicating original multimedia content within a wireless communication device as recited in claim 15, the method further comprising:
classifying the one or more emergency content;
identifying a recipient list for each of the classified multimedia emergency content, wherein the message including the original multimedia content is transmitted to the recipient list.
